(19) United States
(12) Patent Application Publication
(10) Pub. No.: US 2025/0289694 A1
(43) Pub. Date: Sep. 18, 2025

(54) MULTI-FUNCTION HANDLE FOR A MATERIALS-HANDLING VEHICLE

(71) Applicant: Hyster-Yale Group, Inc., Fairview, OR (US)

(72) Inventor: Riccardo Zignani, Cernusco sul Naviglio (IT)

(73) Assignee: Hyster-Yale Group, Inc., Fairview, OR (US)

(21) Appl. No.: 18/606,314

(22) Filed: Mar. 15, 2024

(51) Int. Cl. B66F 9/075

(52) U.S. Cl. CPC B66F 9/0759

(57) ABSTRACT

A materials-handling vehicle, such as, for example, a low-level order-picker, comprises a front side, a rear side, two lateral side, and a handle on one of the two lateral sides. The handle is configured and positioned to be grippable by a hand of an operator, preferably in a neutral position, while standing on a floor or ground on said one of the two lateral sides of the vehicle. The handle is a grabbable brace for the operator. The handle comprises one or more controls including a coast control to cause the vehicle to move forward and/or backward when the coast control is actuated by the operator, preferably by a thumb of the hand of the operator, while standing or walking on said one of the two lateral sides of the vehicle.

### TECHNICAL FIELD

The field of this disclosure relates generally to materials-handling vehicles. More specifically, this disclosure relates to a handle for such a vehicle, such as, for example, a low-level or ground-level order-picker vehicle.

### BACKGROUND

A low-level order picker is a materials-handling vehicle that is designed to be used by an operator to carry items collected throughout a facility. The facility may be a warehouse, and the items may be products stored as inventory in the warehouse. The operator travels with the vehicle throughout the facility to obtain items and to place them on the vehicle. The operator may do so to fill an order of various items for a particular customer or particular shipment. The operator may have a list of the items to obtain together as a group. As each item is obtained, it is placed on the vehicle and carried to the next item pick-up location. When the order is complete, the operator may take the vehicle to a destination, such as a truck or lorry bed or trailer, or staging area, to unload the group of items.

Typical order pickers include a number of lifting load forks (typically two) connected at their heel end to a chassis or body, which includes an operator platform. The forks typically protrude from the rear end of the vehicle. The forks may be designed with a length to pick a single pallet at a time or multiple horizontally spaced pallets (e.g., two) at a time. A fork typically includes one or more load wheels on its bottom side, typically toward its toe end. A lifting mechanism, which may be, for example, hydraulic or electric, pushes the load wheels down so as to lift the forks together with goods, such as one or more pallets on the forks. Typically, the forks and load thereon are raised only enough for the load (e.g., the bottom of a pallet) to clear the floor sufficiently to move without dragging the load on the floor. A low-level order picker vehicle is intended for use collecting items on a floor or ground or from shelves or racks that are low enough in height that the items thereon can be reached by the operator standing on the floor or can be reached from a platform that is raised a limited height (e.g., about 1500 mm or less) above the floor or ground. This is in contrast to some forklifts or so-called “man-up” order pickers, which are designed to access items high above the floor or ground.

The operator platform provides a place where an operator can sit or stand on the vehicle while driving the vehicle. The forward side of the vehicle is typically the side opposite the forks. An operator on the operator platform faces forward to drive the vehicle in a warehouse or similar setting from place to place where items are to be picked and placed on the pallet(s). A steering mechanism, such as a tiller, is also typically provided to steer the pallet vehicle. The steering mechanism is situated such that the operator, when standing on the operator platform and facing forward, can easily grab the steering mechanism with his/her hands. Typically, a steerable traction wheel located on the front end of the vehicle is operably connected to and controlled by the steering mechanism (e.g., tiller or steering wheel) to provide steerability. Controls to activate the lifting mechanism may be located on or near the steering mechanism. Other controls, such as throttle, brake, and/or horn control, for example, may also be provided on the steering mechanism. Alternatively, those controls and/or other controls may be provided at or near the feet of the operator so as to be foot-actuated.

It is sometimes not convenient for an operator to get onto the operator platform of a vehicle to move the vehicle a short distance. Order-picker vehicles are therefore typically designed to have a coasting or walk-along mode. To support that mode, one or more coast buttons may be provided on one or both sides of the vehicle in a position that the operator can reach while standing or walking alongside the vehicle. A typical coast control button causes the vehicle to move forward at a slow rate. For example, a coast speed may be limited to about 4 kph (kilometers per hour). Using the coast mode, the operator can more conveniently move the vehicle a short distance to a next pick-up location than if the operator were required to get on the operator platform, operate the vehicle from the operator platform, and then get off the operator platform.

### Overview of Disclosure

According to one embodiment, a materials-handling vehicle comprises a front side, a rear side, two lateral sides, and a handle on one or both of the two lateral sides. The handle is configured and positioned to be grippable by a hand of an operator while standing on a floor or ground on said one of the two lateral sides of the vehicle. The handle is a grabbable brace for the operator. The handle comprises one or more controls including a coast control to cause the vehicle to move forward and/or backward when the coast control is actuated by the operator standing or walking on said one of the two lateral sides of the vehicle.

In some additional, alternative, or selectively cumulative embodiments, the handle is configured and positioned to be grippable by a hand of the operator in a neutral position.

In some additional, alternative, or selectively cumulative embodiments, the handle comprises a vertically oriented grab bar segment, and the coast control is located on the vertical grab bar segment.

In some additional, alternative, or selectively cumulative embodiments, the coast control is configured and positioned on the vertical grab bar segment to be actuated by a thumb of the operator while the operator's hand grabs the handle.

Optionally, the vehicle comprises a set of forks, and the one or more controls further comprise a fork up-down control to raise and to lower the set of forks, and wherein the fork up-down control is configured and positioned on the vertical grab bar segment to be actuated by a hand of the operator while the operator's hand grabs the handle.

Optionally, the one or more controls further comprise an emergency stop button.

In some additional, alternative, or selectively cumulative embodiments, the materials-handling vehicle according to claim 1 further comprises a standing operator compartment and a backrest along a rear side of the operator compartment, wherein the handle is attached to the backrest.

In some additional, alternative, or selectively cumulative embodiments, the handle is part of a handle assembly comprising a horizontal support arm, wherein the horizontal support arm is attached to the backrest.

In some additional, alternative, or selectively cumulative embodiments, the materials-handling vehicle is a low-level order-picker.

In another embodiment, a handle is designed for use on a side of a materials-handling vehicle. The handle comprises a grab bar segment and one or more controls located on the grab bar segment. The grab bar segment is vertically oriented and positioned near a lateral side of the materials-handling vehicle such that an operator of the materials-handling vehicle can grab the grab bar segment while standing or walking on said lateral side of the materials-handling vehicle. The one or more controls comprise a coast control that can be actuated by the operator standing or walking on said lateral side of the materials-handling vehicle.

In some additional, alternative, or selectively cumulative embodiments, the coast control is positioned on the grab bar segment to be actuated by a thumb of the operator while the operator is standing or walking on said lateral side of the materials-handling vehicle and facing either forward or backward.

In some additional, alternative, or selectively cumulative embodiments, the coast control is positioned on the grab bar segment to be actuated by a thumb of the operator while the operator's forearm is in a neutral position.

Optionally, said one or more controls comprise at least three controls, may comprise a control to lift and lower a load carried by the materials-handling vehicle, and/or may comprise an emergency stop control.

In some additional, alternative, or selectively cumulative embodiments, the one or more controls are located on an outside face of the handle.

According to another embodiment, a method coasts a materials-handling vehicle by an operator. The method comprises standing on the ground or a floor on a lateral side of the materials-handling vehicle facing either a forward direction or a backward direction of the materials-handling vehicle. The method also comprises walking either forward or backward alongside the materials-handling vehicle as it coasts. During said walking, the method also comprises grabbing a vertically oriented bar segment of the materials-handling vehicle with a hand in a neutral position and activating a coast control on the bar segment with a thumb of the hand.

In some additional, alternative, or selectively cumulative embodiments, the hand is a left hand of the operator, and the vertically oriented bar segment is on a right side of the materials-handling vehicle.

In some additional, alternative, or selectively cumulative embodiments, the hand is a right hand of the operator, and the vertically oriented bar segment is on a left side of the materials-handling vehicle.

According to yet another embodiment, a device is designed for use from a lateral side of a materials-handling vehicle off and outside of the materials-handling vehicle. The device comprises a means for holding the materials-handling vehicle by a hand of the operator in a neutral position while the operator stands on the lateral side of the materials-handling vehicle facing either forward or backward and a means for activating a coasting function of the materials-handling vehicle using a thumb of the hand while holding the means for holding with a neutral hand position while the operator walks on the lateral side of the materials-handling vehicle facing either forward or backward.

As one skilled in the art will appreciate in light of this disclosure, certain embodiments of the vehicles and methods disclosed herein may be capable of achieving certain advantages, including, in some cases, one or more of the following: (1) providing a grabbable brace point for an operator entering or exiting an operator compartment of a materials-handling vehicle; (2) providing a grabbable brace point for an operator standing or walking alongside a materials-handling vehicle; (3) providing a more reachable and convenient coasting control for a materials-handling vehicle; (4) providing a more reachable and convenient fork height control for an operator facing backward on a materials-handling vehicle; (5) improving the ergonomics of materials-handling vehicles, particularly low-level order pickers; and (6) improving efficiency for operating a materials-handling vehicle, particularly a low-level order picker. The foregoing and other advantages of various embodiments will be apparent from the following detailed description of example embodiments, which proceeds with reference to the accompanying drawings, which are briefly introduced immediately below.

### BRIEF DESCRIPTION OF THE DRAWINGS

FIG. 1 is an isometric drawing of a low-level order-picker vehicle from a front-right-top perspective, according to one embodiment.

FIG. 2 is right side view of the low-level order-picker vehicle of FIG. 1.

FIG. 3 is left side view of the low-level order-picker vehicle of FIG. 1.

FIG. 4 is top view of the low-level order-picker vehicle of FIG. 1.

FIG. 5 is front side view of the low-level order-picker vehicle of FIG. 1.

FIG. 6 is rear side view of the low-level order-picker vehicle of FIG. 1.

FIG. 7 is a close-up isometric drawing of a multi-function handle assembly on the left side of the low-level order-picker vehicle of FIG. 1, detached from the vehicle, from a left-rear-top perspective.

FIG. 8 is an isometric drawing of the left multi-function handle assembly of FIG. 7 from a left-front-bottom perspective.

FIG. 9 is a front side view the left multi-function handle assembly of FIG. 7.

FIG. 10 is a rear side view the left multi-function handle assembly of FIG. 7.

FIG. 11 is a left side view the left multi-function handle assembly of FIG. 7.

FIG. 12 is a top view the left multi-function handle assembly of FIG. 7.

FIG. 13 is a bottom view the left multi-function handle assembly of FIG. 7.

### DETAILED DESCRIPTION

### Preliminary Notes

Example embodiments are described below with reference to the accompanying drawings. Unless otherwise expressly stated, the sizes, positions, etc., of components, features, elements, etc., as well as any distances therebetween, are not necessarily to scale, and may be disproportionate and/or exaggerated for clarity.

The embodiments described herein are merely examples, set forth by way of illustration only and not limitation. Those skilled in the art will recognize in light of the teachings herein that there are alternatives, variations and equivalents to the example embodiments described herein and their component parts. For example, other embodiments are readily possible, variations can be made to the embodiments described herein, and there may be equivalents to the components, parts, or steps that make up the described embodiments.

For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

The terminology used herein is for the purpose of describing particular example embodiments only and is not intended to be limiting. As used herein, the singular forms “a,” “an” and “the” are intended to include the plural forms as well, unless the context clearly indicates otherwise. It should be recognized that the terms “comprise,” “comprises,” “comprising,” “include,” “includes,” “including,” “has,” “have,” and “having,” when used in this document, are open-ended and specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween. Unless indicated otherwise, terms such as “first,” “second,” etc., are only used to distinguish one element from another and not to imply any relative order, placement, or ranking. For example, one element could be termed a “first element” and similarly, another element could be termed a “second element,” or vice versa. The same is true of labels like (a), (b), (c) or (1), (2), (3), etc. The section headings used herein are for organizational purposes only and are not to be construed as limiting the subject matter described.

Unless indicated otherwise, the terms “about,” “thereabout,” “substantially,” etc. mean that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Spatially relative terms, such as “right,” left,” “below,” “beneath,” “lower,” “above,” and “upper,” and the like, may be used herein for ease of description to describe one element's or feature's relationship to another element or feature, as illustrated in the drawings. It should be recognized that the spatially relative terms are intended to encompass different orientations in addition to the orientation depicted in the drawings. For example, if an object in the figures is turned over, elements described as “below” or “beneath” other elements or features would then be oriented “above” the other elements or features. Thus, the term “below” can, for example, encompass both an orientation of above and below. An object may be otherwise oriented (e.g., rotated 90 degrees or at other orientations) and the spatially relative descriptors used herein may be interpreted accordingly.

Unless clearly indicated otherwise, all functional or operative connections may be direct or indirect. Similarly, unless clearly indicated otherwise, all physical connections may be rigid or non-rigid, permanent or temporary, direct or indirect (e.g., via intermediary components).

Like numbers refer to like elements throughout. Thus, the same or similar numbers may be described with reference to other drawings even if they are neither mentioned nor described in the corresponding drawing. Also, even elements that are not denoted by reference numbers may be described with reference to other drawings. Additionally, the drawings may include non-essential elements that are included only for the sake of thoroughness. These non-essential elements may be removed entirely or left only in outline form if drawing changes are desired to create greater clarity.

Not every feature shown in every drawing is labeled with a reference number, even though the same feature may be labeled with a reference number on other drawings. Reference numbers have been omitted where it is believed they would unnecessarily clutter a drawing. However, all rights are reserved to add reference numbers to the drawings to clarify aspects of the embodiments. Moreover, some views omit some features shown in other views. Finally, the drawings sometimes illustrate variations from one drawing to another, even where those drawings are intended to depict the same embodiment.

### EXAMPLE EMBODIMENTS

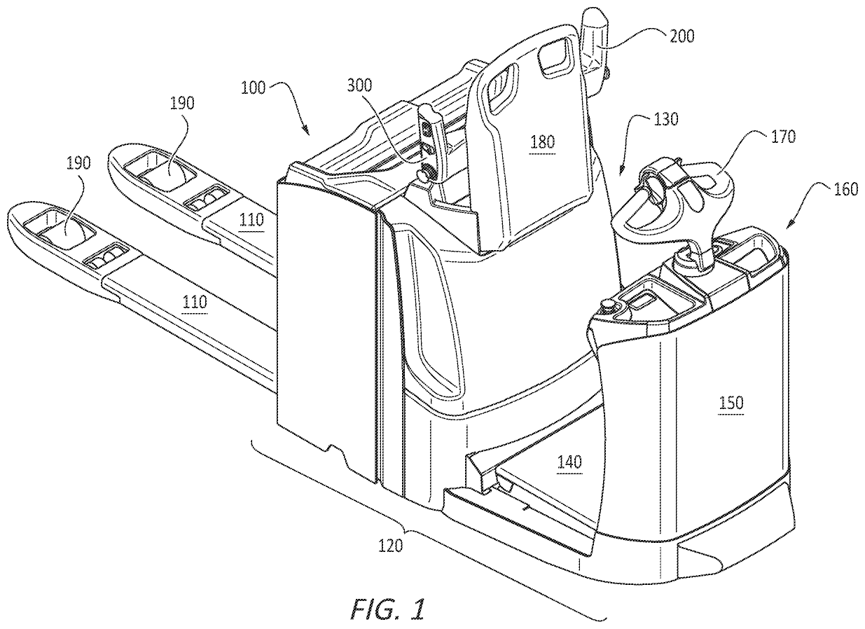

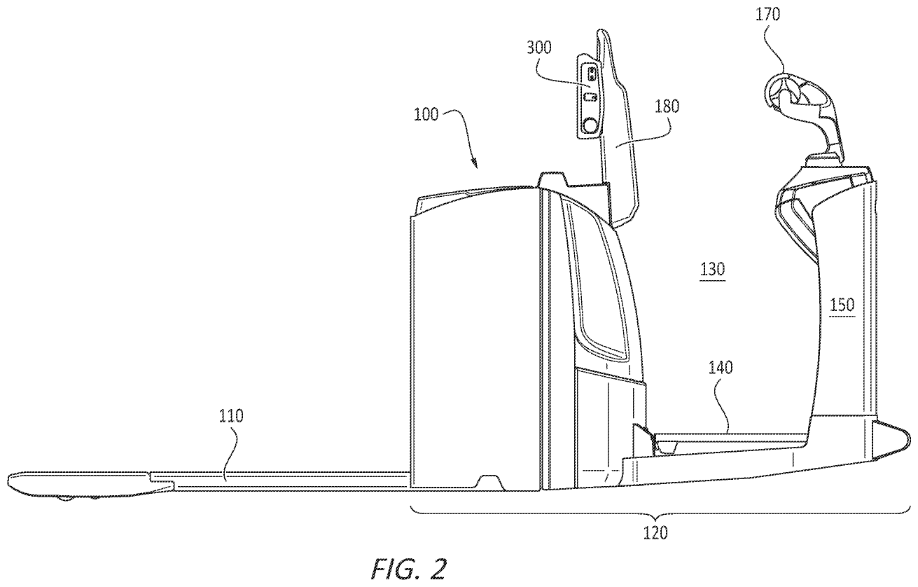

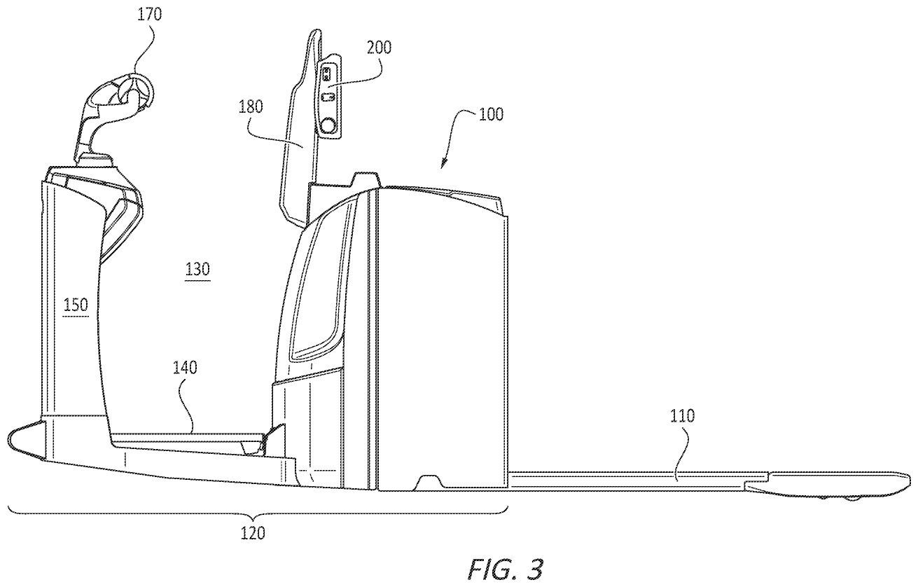

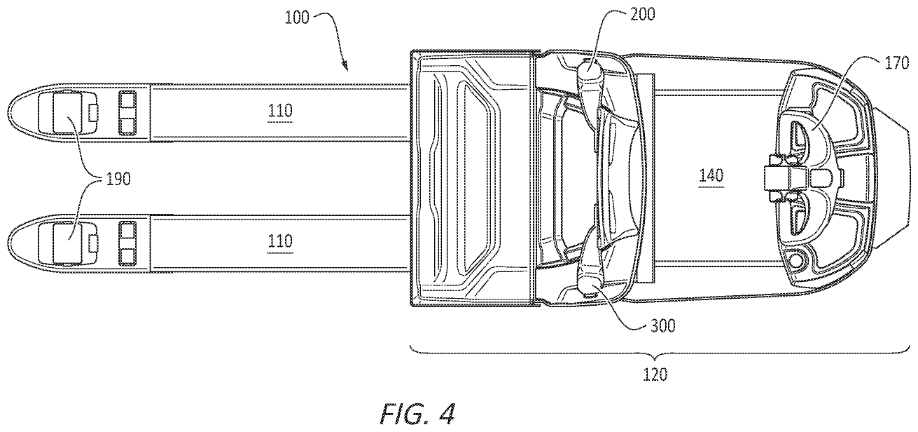

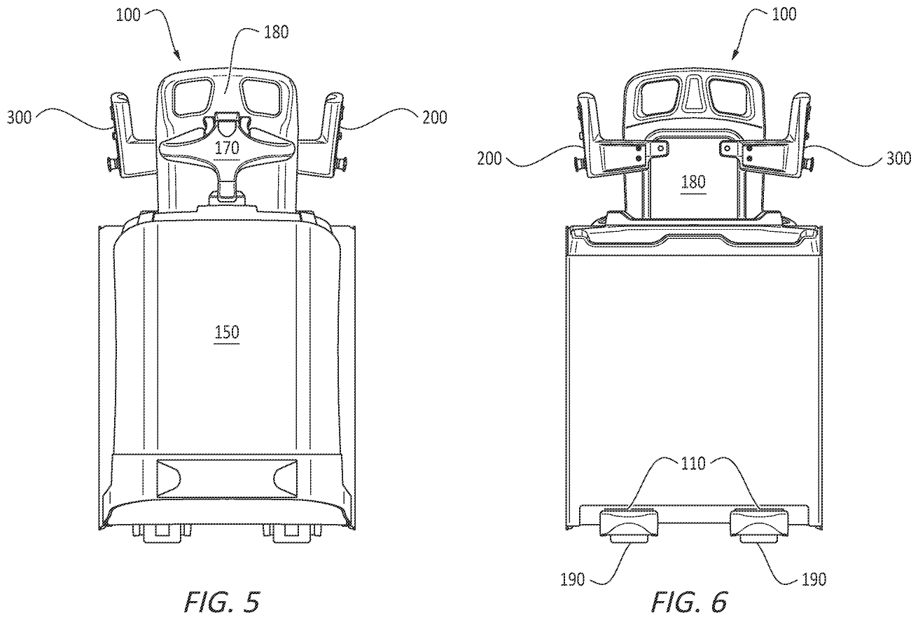

FIGS. 1-6 illustrate an example of a low-level order-picker vehicle 100, according to one embodiment. The vehicle 100 comprises two forks 110 and a main body 120. The main body 120 comprises an operator compartment 130 above an operator platform 140. On a front end 150 of the main body 120 is an operator control stand 160 having operator controls facing the operator compartment 130. One of the operator controls is a tiller 170, which can be used to steer the vehicle 100 by controlling the direction of a steerable front wheel or wheels (not shown). Alternatively, a steering wheel or other direction controller can be used in place of the tiller 170. The steerable front wheel(s) may be located below the control stand 160. Alternatively or additionally, rear wheel(s) may be steerable.

Other operator controls may be located on the operator control stand 160 and/or the tiller 170. Examples of operator controls include a hand throttle, brake, fork lift/lower controls, horn, emergency stop button, etc. Alternatively, an accelerator pedal and/or a brake pedal may be provided on or near the bottom of the operator control stand 160 or the operator platform 140. The operator controls are designed to face an operator standing on the operator platform 140, i.e., in the operator compartment 130, facing the forward direction or front 150 of the vehicle 100, in which case the forks 110 are behind the operator. That is, the operator's back is to the forks 110 when the operator is standing on the operator platform in position to operate the operator controls, such as the tiller 170.

The operator platform 140 may have a deadman sensor that detects whether the operator is on the platform 140. If no operator is detected on the platform 140, operation of the driving functions of the vehicle 100 may be disabled. However, as explained below, a coast control on side handles can override the deadman lock.

Between the operator compartment 130 and the forks 110 under one or more enclosures may be a power source and components for providing motive force to the vehicle 100 to drive it forward (and possibly backwards) via wheels (not shown) and to raise and lower the forks 110. The vehicle 100 may, for example, be electric, having a motor; or gas-powered, having an engine; or a hybrid electric-fuel vehicle. The vehicle 100 may be powered by one or more electric batteries, fuel, or a hydrogen fuel cell, for example. Alternatively, some or all of the power source and/or related components may be located between the operator compartment 130 and the front end 150—in the general area of what is labeled as the operator control stand 160 in FIGS. 1-6. That is, the power source and/or related components may be located in front of or behind the operator compartment, or both. As shown in FIGS. 1-6, the portion of the main body 120 behind the operator compartment 130 is larger than the control stand 160, but the opposite is equally possible, and more of the internal components of the truck 100 may be forward from the operator compartment 130.

A backrest 180 is provided on the rear side of the operator compartment. The backrest 180 is positioned vertically to permit the operator to lean his or her back on the backrest 180 while standing on the operator platform 140 and operating the vehicle 100. The backrest 180 is centered side-to-side on the vehicle 100. The backrest enhances the comfort of the operator while using the vehicle 100.

The vertical lift range of the forks 110 may be just enough to lift a typical pallet off the floor sufficiently to move it without touching the floor, for example, about 120 mm (approximately 4.7 inches). Alternatively, the vertical lift range of the forks 110 may be greater to raise the forks to a more comfortable height to place items (especially heavy items) on the forks 110 or a pallet or other holding platform on the forks 110. For example, the vertical lift range of the forks 110 may be approximately waist height for an average person or average male person, for example from about 700 (approximately 27.6 inches) mm to about 800 mm (31.5 inches). The forks 110 may raise and lower by any mechanism, including, for example, hydraulics. For example, each fork 110 may have a lift rod that extends longitudinally within or underneath the fork 110 from the main body 120 to a set of one or more load rollers 190, and a hydraulic piston pushes the rod to press the load rollers 190 down in the ground/floor and the forks 110 correspondingly up.

The vehicle 100 also includes two handles 200 and 300 on the left and right sides of the vehicle 100, respectively. The handles 200 and 300 are reachable and grabbable from the sides of the vehicle 100 when the operator is not in the operator compartment 130. For example, the handle 300 is easily and conveniently grabbable by an operator standing on the right side of the vehicle 100. Similarly, the handle 200 is easily and conveniently grabbable by an operator standing on the left side of the vehicle 100. As shown, each handle 200 and 300 is attached to a rear side of the backrest 180, but the handles 200 and 300 can be attached to any part of the vehicle 100, such as the main body 120 or one of its cover pieces, or the operator control stand 150. When the handles 200 and 300 are placed in close proximity to the forks 110, they may be more convenient for an operator to reach and use between acts of placing items on or off the forks 110. According to one embodiment, the handles 200 and 300 are positioned somewhat in front of the heels of the forks 110.

The handles 200 and 300 are located on the lateral sides of the vehicle. The more laterally outward they are placed, the more convenient it may be for an operator to grab them. However, it may not be desirable to place the handles 200 and 300 so far out laterally that they increase the overall lateral dimension of the vehicle 100, the size and footprint of which is often constrained by other factors. It may be preferable to place the handles 200 and 300 such that they extend laterally slightly less than the maximum laterally positioned part(s) of the vehicle 100. In that way, some other part of the vehicle would first make contact with an object on the side before the handle 200 or 300 makes contact with that object. In that way, the handles 200 and 300, which may not be as durable as other parts of the vehicle 100, are protected in the event of a side-impact collision.

According to one embodiment, the vehicle 100 has a maximum lateral dimension of about 750 mm, the backrest 180 is about 418 mm wide, and the handles 200 and 300 extend no more than about 135 mm from the side edge of the backrest 180. According to one embodiment, the handles 200 and 300 extend no more than about 345 mm from the longitudinal center of the vehicle 100.

The handles 200 and 300 are preferably located at a vertical height such that they are comfortably grabbed by one hand of an operator standing on the floor/ground to the side of the vehicle 100 and facing forward or backward and with his/her elbow bent at a comfortable angle (e.g., about 90 degrees±5, 10, or 15 degrees) and with his/her forearm and hand are in a neutral position (i.e., with the thumb up and the little finger down). The handles 200 and 300 are preferably also located at a vertical height such that each one can be comfortably grabbed by one hand of an operator standing on the operator platform and turning to that side of the vehicle 100. According to one embodiment, the handles 200 and 300 are located at a height from about 900 mm to about 1400 mm above the floor/ground.

The handles 200 and 300 are braceable grab points that the operator can use to aid in getting on and off the vehicle 100, in particular the operator platform 140. For example, an operator may grab the handle 300 with his/her left hand when entering the operator compartment 130 from the right side of the vehicle 100. As another example, an operator may grab the handle 200 with his/her right hand when entering the operator compartment 130 from the left side of the vehicle 100. The handles 200 and 300 are braceable grab points that the operator can hold while walking alongside the vehicle 100 as the vehicle 100 moves in coast mode. For example, an operator may hold the handle 300 with his/her left hand while walking forward on the right side of the vehicle 100. As another example, an operator may hold the handle 200 with his/her right hand while walking forward on the left side of the vehicle 100. The handles 200 and 300 may include coast controls, as explained in more detail below, to facilitate this grabbing walk-along coasting operation. In fact, as explained below, the handles 200 and 300 may be multi-function handles.

The multi-function handle 300, on the right side of the vehicle 100, is a mirror image of the multi-function handle 200 described below with the same buttons and functionality. In fact, a handle assembly on the left side of the vehicle 100 is a mirror image of the handle assembly on the right side of the vehicle 100. By providing two multi-function handles-one on each side of the vehicle 100—an operator is able to have the same benefits of the multi-function handle when working on either side of the vehicle 100. That can be useful when working, for example, in an aisle between two rows of shelving where items must be picked from shelves on both sides of the vehicle 100. Alternatively, the vehicle 100 may have a single multi-function handle on just the right side of the vehicle 100 or just the left side of the vehicle 100. Alternatively, the left and right handles 200 and 300 may differ from one another in terms of their position (vertical and/or lateral), shape, size, and/or functionality (e.g., controls provided thereon). That is, the handles 200 and 300 need not be symmetric.

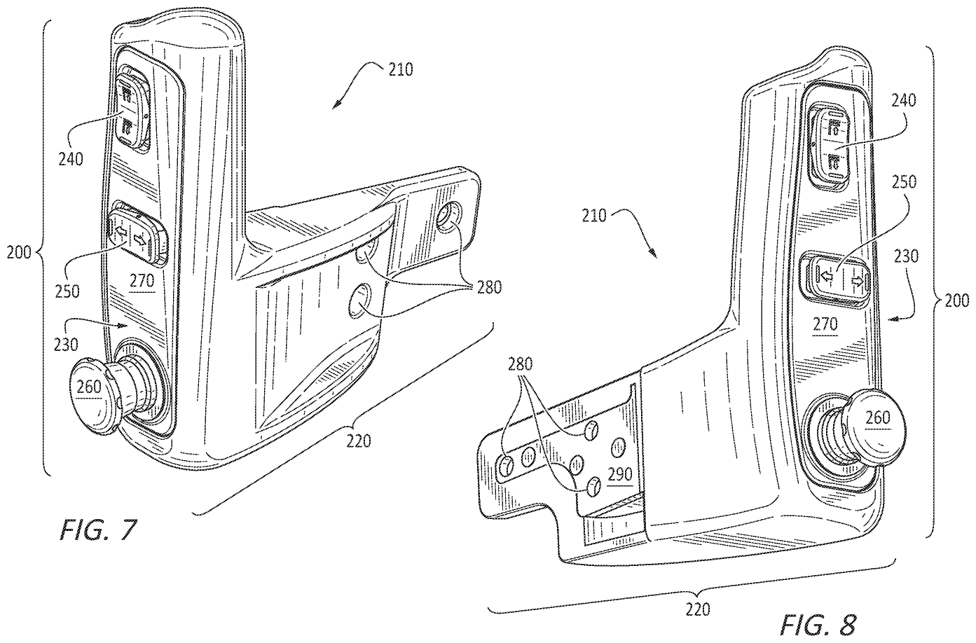

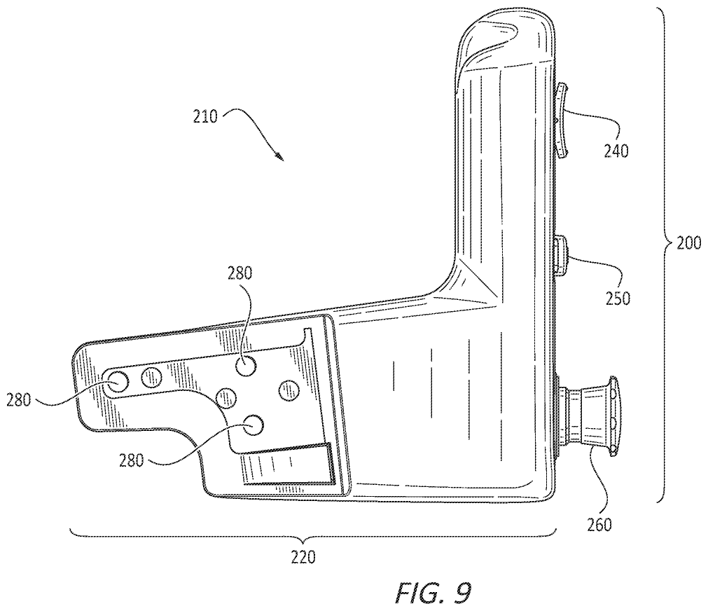

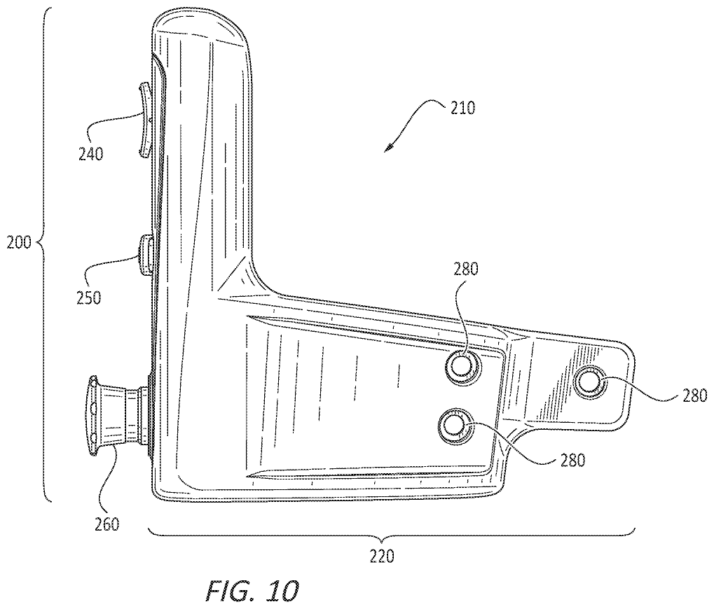

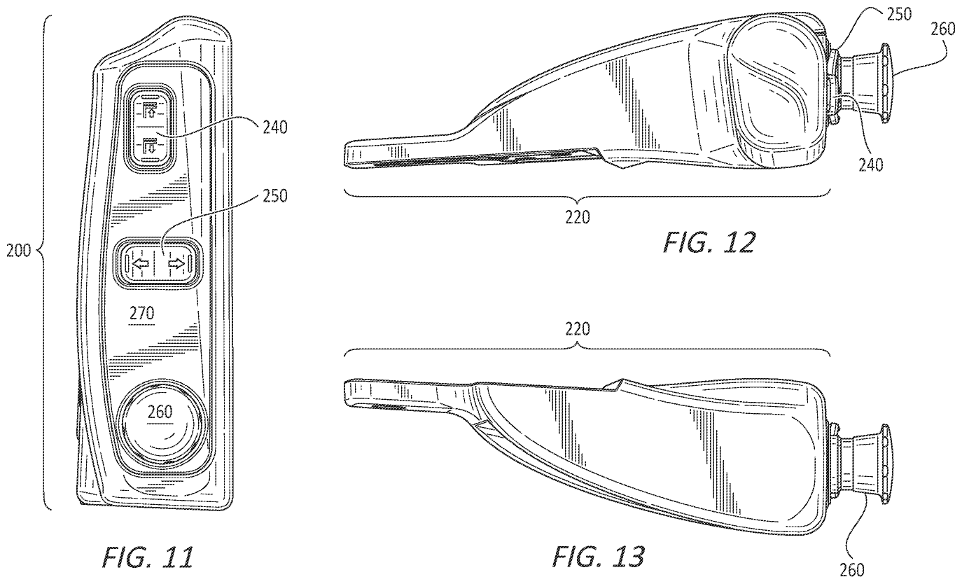

FIGS. 7-13 illustrate a handle assembly 210 detached from the left side of the low-level order-picker vehicle 100. The handle 200 is a part of the handle assembly 210. The handle assembly 210 is generally L-shaped and comprises a horizontal support arm 220 and the handle 200. The handle 200 or at least a portion of it is a vertical grabbable section, a vertically oriented grab bar segment, or the like. The handle 200 or a portion of it is a cylinder, cylinder-like, shaft, or shaft-like hand-grippable handle. An operator can grab, grip, or hold the handles 200 and 300 with his/her fingers and/or thumb wrapped fully or partially around the handle 200 and 300 or a portion thereof. Other than having a vertical grabbable section, a vertically oriented grab bar segment, or the like suitably attachable to the vehicle 100 at a suitable location, the handle 200 and the handle assembly 210 may have any shape, form, design and/or appearance.

An outer face 230 of the handle 200 has three controls 240, 250, and 260, as shown, and described in more detail below. The outer face 230 also has a face plate 270, which is preferably removable. The face plate 270 may be secured by two screws, as shown, or other means (e.g., one or more nails, one or more bolts, one or more rivets, friction fit, snap fit, adhesive fit, etc.). Removal of the face plate 270 can facilitate installation, removal, and/or service of the controls 240, 250, and 260.

Several mounting holes 280 on the horizontal support arm 220, particular near its distal end, can be used to attach the handle assembly 210 to the backrest 180 (or other part of the vehicle 100) using bolts or similar mechanical fasteners through the mounting holes 290 and corresponding mounting holes on the backrest 180. More or less mounting holes may be provided. Other attachment means (e.g., nails, bolts, rivets, friction fit, snap fit, adhesive fit, etc.) are also possible to attach the handle assembly 210 to the vehicle 100.

As shown, the handle assembly 210 includes a mounting plate 290, which can help secure the handle assembly 210 to the backrest 180. The mounting plate 290 may be metal or a hard plastic, for example, whereas other parts of the handle assembly 210 may be a softer plastic or rubber or similar material to provide a more comfortable feel to the operator's hand. The mounting plate 290 may have holes to accept screws or other fasteners to attach the mounting plate 290 to the rest of the handle assembly 210. The parts of the handle assembly 210 excluding the face plate 270, the controls 240-260, the mounting plate 290 may be one integral piece that is formed by molding or three-dimensional printing, for example.

The handle 200 is preferably sized to comfortably be grabbed and gripped by an average human hand. According to one embodiment, the dimensions of the handle 200 may be approximately 250 mm tall, about 265 mm wide (laterally), about 83 mm thick (front to back), and about 80 mm in approximate diameter.

Although the location, orientation, and some aspects of the size of the handle 200 relative to the vehicle and the controls provided on the handle 200 may be functional, the shape and/or appearance of the handle 200 may be ornamental, as may be the arrangement of the controls.

According to the illustrated embodiment, the handle 200 comprises three operator-actuatable controls 240-260 on the outside (left side when mounted on the vehicle 100). First, a fork up-down control 240 is provided on an upper portion of the handle 200. The fork up-down control 240 may be a binary up-neutral-down switch (such as a two-way rocker switch) that simply turns on a raise mode if the top portion is depressed or turns on a lower mode if the bottom portion is depressed. Alternatively, the fork up-down control 240 may be a continuous or graduated control that not only activates a lifting/lowering mechanism in a desired direction but also controls the speed and/or extent of motion based on the extent to which the top or bottom portion of the control 240 is depressed.

An advantage of providing the fork up-down control 240 on the handle 200 is that it simplifies vertical control of the forks 110 while the operator is facing backwards on the vehicle 100. This scenario happens frequently when the vehicle 100 enters or exits a truck or lorry to drop off or pick up a load. If the only vertical fork controls are on the tiller 170 or otherwise on the front side of the operator compartment 130, the operator must turn to look behind him/her to see the forks 110 while facing forward to activate their vertical controls. Conversely, the operator may attempt to face backwards to see the forks 110 while reaching behind him/her to reach the vertical fork controls on the tiller 170. Either way, that can be uncomfortable to the operator and cause strain, especially when done for an extended time or repeatedly over a long shift and/or multiple shifts. Having the fork up-down control 240 on the handle 200 is more comfortable for the operator and therefore more sustainable for the operator to do during long or repeated shifts. As a result, operator efficiency can be improved. Similarly, throttle, brake, and/or other controls can also be incorporated onto the handle 200 to improve ergonomics when the truck 100 is driven in reverse.

If the forks 110 have a sufficient range of motion to lift the forks to a higher, more comfortable loading/unloading position, the operator can use that capability via the fork up-down control 240 to raise the forks before setting an item on the forks (or pallet thereon). This is particularly helpful for a heavy item. After picking and placing the item, the operator can then use the fork up-down control 240 to lower the forks 110 before driving or coasting the vehicle 100.

Second, a coast control 250 is provided in or near the middle section of the handle 200. The coast control 250 is located in a position to be activated by a thumb of the operator as the operator naturally grabs the handle 200. For example, the operator may grab the handle 200 with his/her left hand, depress the thumb-activated coast control 250 with his/her left thumb and walk alongside the vehicle 100 as it moves backward in coast mode. The operator may do so while his/her left arm and hand are in a natural, neutral position, such as how a person would hold a ski pole or hiking pole. The act of activating coasting of the vehicle 100 from this position does not impede the natural walking motion of the operator. In fact, the handle 200 acts as a grabbable brace that can stabilize the operator as he/she walks.

Third, an emergency stop button 260 is provided on a lower portion of the handle 200. Depressing the emergency stop button 260 may shut down some or all of the functions of the vehicle 100, such as forward/backward motion and/or fork up/down motion. Depressing the emergency stop button 260 may also activate a brake and/or an alarm, such as a horn or other audible alarm, a light or other visual alarm, and/or cause a distress signal to be sent wirelessly to a dispatch station, office, or other appropriate location.

As illustrated in FIGS. 7, 8, and 11, the controls 240-260 may have indicia to visually indicate their function. The indicia may comprise graphics or text or both. Such indicia may alternatively be provided on the face plate 270 or elsewhere near the controls 240-260. The indicia is optional and may be omitted.

More or fewer controls may be provided on the multi-function handle 200, and their positions may be different from what is illustrated in the attached drawings, which illustrate just one example of the multi-function handle 200. For example, the same or different controls may be provided on the inside, front, or rear of the multi-function handle 200. Additionally, a control, such as a button, may be provided on the top side of the multi-function handle 200 or on other parts of the handle assembly 210 easily reachable by a finger or other part of the operator's hand.

According to one embodiment, the multi-function handles 200 and 300 are examples of means for holding the materials-handling vehicle by a hand of the operator in a neutral position while the operator stands on the lateral side of the materials-handling facing either forward or backward. Also, the coast control 250 and a similar coast control on the handle 300 are examples of means for activating a coasting function of the materials-handling vehicle using a thumb of the hand while holding the handle 200 or 300 with a neutral hand position while the operator walks on the lateral side of the materials-handling facing either forward or backward.

According to one example use case, an operator starts with the vehicle 100 with no load and a pick-up list. The operator drives the vehicle 100 near an empty pallet with the forks 110 facing the pallet. The operator turns around and stands backward on the operator platform 140 while positioning the forks to enter the pallet pockets. While standing backward on the operator platform 140, the user drives the vehicle in reverse to fully place the forks in the pallet. The operator may do so using the coast control 250 on one or more of the handles 200 or 300 while continuing to face backward. The operator then raises the forks further to lift the pallet off the ground/floor, again using the fork up-down control 240 on one of the handles 200 or 300 and while facing backward. The operator can then turn around, face forward, and drive the vehicle to the first pick-up location. After stopping and dismounting from the vehicle while grabbing one of the handles 200 or 300 for stability, the operator gets the first item and places it on the pallet on the forks 110. If the second item is far away, the operator will likely choose to get in the operator compartment 130 (grabbing one of the handles 200 or 300 for upper-body assistance and/or stability during entrance) and drive the vehicle 100 in its usual driving mode to the second pick-up location. If the second pick-up location is relatively close to the first pick-up location, it may be more convenient for the operator to move the vehicle 100 in coast mode using the coast control 250 without having to re-enter the vehicle operator compartment 130. The operator can do so walking with the coasting vehicle 100 while holding the handle 200 or 300 and depressing the coast control 250. The operator continues this pattern item by item, deciding for each item whether to coast or drive, whether to enter and exit the operator compartment 130, and whether to raise the forks to a more comfortable height for setting down the item. In each case, the operator uses one or more of the functions of the multifunction handles 200 and/or 300, including coasting, fork raising/lowering, and/or grabbing or holding the handles 200 or 300. After obtaining all items on the pick-up list, the operator drives the vehicle 100 near a truck bed and could turn around on the operator platform 140 to move the truck backwards to a position where the pallet is to be left using the coast control 250 on the handle 200 or 300; use the fork up/down control 240 on the handle 200 or 300 to drop off the pallet; and use the tiller 170 to move the truck away from the pallet and out of the truck.

In an alternative use case, the operator takes a loaded pallet out of a truck or trailer (or other area) and places the items from the pallet on shelves or other places throughout a facility. In that alternative use case, the features of the multifunction handle 200 and 300 are equally useful.

### CONCLUSION

The terms and descriptions used above are set forth by way of illustration and example only and are not meant as limitations. Those skilled in the art will recognize that many variations, enhancements and modifications of the concepts described herein are possible without departing from the underlying principles of the invention. For example, skilled persons will appreciate that the subject matter of any sentence, paragraph, or drawing can be combined with subject matter of some or all of the other sentences, paragraphs, or drawings, except where such combinations are mutually exclusive. The scope of the invention should therefore be determined only by the following claims, claims presented in a continuing patent application or a post-issuance proceeding, and equivalents to such claims.

1. A materials-handling vehicle comprising:
a front side, a rear side, and two lateral sides; and
a handle on one of the two lateral sides, wherein the handle is configured and positioned to be grippable by a hand of an operator while standing on a floor or ground on said one of the two lateral sides of the vehicle, wherein the handle is a grabbable brace for the operator, and wherein the handle comprises one or more controls including a coast control to cause the vehicle to move forward and/or backward when the coast control is actuated by the operator standing or walking on said one of the two lateral sides of the vehicle.

2. A materials-handling vehicle according to claim 1, wherein the handle is configured and positioned to be grippable by a hand of the operator in a neutral position.

3. A materials-handling vehicle according to claim 1, wherein the handle comprises a vertically oriented grab bar segment, and the coast control is located on the vertical grab bar segment.

4. A materials-handling vehicle according to claim 3, wherein the coast control is configured and positioned on the vertical grab bar segment to be actuated by a thumb of the operator while the operator's hand grabs the handle.

5. A materials-handling vehicle according to claim 3, wherein the vehicle comprises a set of forks, wherein the one or more controls further comprise a fork up-down control to raise and to lower the set of forks, and wherein the fork up-down control is configured and positioned on the vertical grab bar segment to be actuated by a hand of the operator while the operator's hand grabs the handle.

6. A materials-handling vehicle according to claim 1, wherein the vehicle comprises a set of forks, and wherein the one or more controls further comprise a fork up-down control to raise and to lower the set of forks.

7. A materials-handling vehicle according to claim 1, wherein the one or more controls further comprise an emergency stop button.

8. A materials-handling vehicle according to claim 1, further comprising:
a standing operator compartment; and
a backrest along a rear side of the operator compartment, wherein the handle is attached to the backrest.

9. A materials-handling vehicle according to claim 8, wherein the handle is part of a handle assembly comprising a horizontal support arm, wherein the horizontal support arm is attached to the backrest.

10. A materials-handling vehicle according to claim 1, wherein the materials-handling vehicle is a low-level order-picker.

11. A handle for use on a side of a materials-handling vehicle, the handle comprising:
a grab bar segment, wherein the grab bar segment is vertically oriented and positioned near a lateral side of the materials-handling vehicle such that an operator of the materials-handling vehicle can grab the grab bar segment while standing or walking on said lateral side of the materials-handling vehicle; and
one or more controls located on the grab bar segment, wherein the one or more controls comprise a coast control that can be actuated by the operator standing or walking on said lateral side of the materials-handling vehicle.

12. A handle according to claim 11, wherein the coast control is positioned on the grab bar segment to be actuated by a thumb of the operator while the operator is standing or walking on said lateral side of the materials-handling vehicle and facing either forward or backward.

13. A handle according to claim 11, wherein the coast control is positioned on the grab bar segment to be actuated by a thumb of the operator while a forearm of the operator is in a neutral position.

14. A handle according to claim 11, wherein said one or more controls comprise at least three controls.

15. A handle according to claim 14, wherein said at least three controls comprise a control to lift and lower a load carried by the materials-handling vehicle.

16. A handle according to claim 14, wherein said at least three controls comprise an emergency stop control.

17. A handle according to claim 11, wherein said one or more controls are located on an outside face of the handle.

18. A method for coasting a materials-handling vehicle by an operator, the method comprising:
standing on the ground or a floor on a lateral side of the materials-handling vehicle facing either a forward direction or a backward direction of the materials-handling vehicle;
walking either forward or backward alongside the materials-handling vehicle as it coasts; and
during said walking, grabbing a vertically oriented bar segment of the materials-handling vehicle with a hand in a neutral position and activating a coast control on the bar segment with a thumb of the hand.

19. A method according to claim 18, wherein said walking is forward, the hand is a left hand of the operator, and the vertically oriented bar segment is on a right side of the materials-handling vehicle.

20. A method according to claim 18, wherein said walking is forward, the hand is a right hand of the operator, and the vertically oriented bar segment is on a left side of the materials-handling vehicle.

21. A device for use from a lateral side of a materials-handling vehicle off and outside of the materials-handling vehicle, the device comprising:
a means for holding the materials-handling vehicle by a hand of an operator in a neutral position while the operator stands on the lateral side of the materials-handling facing either forward or backward; and
a means for activating a coasting function of the materials-handling vehicle using a thumb of the hand while holding the means for holding with a neutral hand position while the operator walks on the lateral side of the materials-handling facing either forward or backward.
